(19) United States
(12) Patent Application Publication
(10) Pub. No.: US 2025/0170821 A1
(43) Pub. Date: May 29, 2025

(54) RECORDING APPARATUS, METHOD FOR CONTROLLING RECORDING APPARATUS, AND STORAGE MEDIUM

(71) Applicant: CANON KABUSHIKI KAISHA, Tokyo (JP)

(72) Inventors: ATSUHIKO MASUYAMA, Kanagawa (JP); TOMOKI KOBAYASHI, Kanagawa (JP); YUHEI OIKAWA, Kanagawa (JP); KOHEI SATO, Kanagawa (JP)

(21) Appl. No.: 18/951,735

(22) Filed: Nov. 19, 2024

(30) Foreign Application Priority Data
Nov. 28, 2023 (JP) 2023-200414
Sep. 24, 2024 (JP) 2024-165404

(51) Int. Cl. B41J 2/045; B41J 2/165; B41J 2/21

(52) U.S. Cl. CPC B41J 2/0451; B41J 2/04563; B41J 2/04573; B41J 2/0458; B41J 2/04588; B41J 2/16505; B41J 2/2142

(57) ABSTRACT

A recording apparatus includes a record head having multiple record elements for ejecting a recording agent and recording an image on a record medium by driving the multiple record elements, a drive control unit driving the multiple record elements while the multiple record elements are divided into multiple blocks to vary driving timing for each block, a generation unit generating drive-recording data in which an ejection inspection pattern for inspecting ejection states of the record elements is reflected in recording data generated based on image data, and an inspection unit inspecting an ejection state of a record element to be inspected driven based on the ejection inspection pattern. The generation unit generates the drive-recording data so that the drive control unit does not drive a record element other than the record element to be inspected in a block that includes the record element to be inspected.

### BACKGROUND

### Field

The present disclosure relates to a recording apparatus, a method for controlling the recording apparatus, and a storage medium.

### Description of the Related Art

An inkjet recording apparatus that ejects ink droplets from a record head to record an image on a record medium is conventionally known. There has been proposed a technique for inspecting the ejection state of an ink ejection nozzle (hereinafter, nozzle) provided in the record head by utilizing ink droplet ejection from the record head in such a recording apparatus.

Japanese Patent Laid-Open No. 2020-142503 discloses a method for determining the ejection state of a record head provided with a plurality of sensors for detecting the ejection states of respective nozzles, wherein in addition to a first driving condition for recording an image, a second driving condition different from the first driving condition is provided based on inspection data. This makes it possible to determine the ejection states of the nozzles based on output from each of the plurality of sensors under the second driving condition.

### SUMMARY

In continuous paper recording, in the case of determining the ejection state of a record head to ensure the reliability of the record head, since it is difficult to provide an area for inspection on media, the recording is stopped every time recording corresponding to a predetermined distance is performed, and an ejection check is made. In this case, however, there is such a problem that downtime is unavoidable.

A recording apparatus according to one aspect of the present disclosure includes a record head having a plurality of record elements for ejecting a recording agent and configured to record an image on a record medium by driving the plurality of record elements, a drive control unit configured to drive the plurality of record elements while the plurality of record elements are divided into a plurality of blocks to vary driving timing for each block, a generation unit configured to generate drive-recording data in which an ejection inspection pattern for inspecting ejection states of the record elements is reflected in recording data generated based on image data, and an inspection unit configured to inspect an ejection state of a record element to be inspected driven based on the ejection inspection pattern, and the generation unit generates the drive-recording data so that the drive control unit does not drive a record element other than the record element to be inspected in a block that includes the record element to be inspected.

Further features of the present invention will become apparent from the following description of exemplary embodiments with reference to the attached drawings.

### BRIEF DESCRIPTION OF THE DRAWINGS

FIG. 1 is a perspective view for describing the structure of a recording apparatus provided with a full-line record head;

FIG. 2 is a block diagram showing a control configuration of the recording apparatus;

FIGS. 3A to 3C are diagrams showing a multilayer wiring structure near a record element formed on a silicon substrate;

FIG. 4 is a block diagram showing a control configuration of temperature detection using an element substrate;

FIGS. 5A and 5B are diagrams showing a temperature waveform output from a temperature detection element and a temperature change signal corresponding to the waveform;

FIG. 6 is a diagram describing a configuration of block driving;

FIG. 7 is a schematic diagram of times at which latch signals are input;

FIG. 8 is a block diagram describing a signal generation unit;

FIG. 9 is a diagram showing an ejection inspection pattern;

FIG. 10 is a flow diagram of ejection inspection;

FIG. 11 is a diagram describing generation of an ejection inspection pattern;

FIG. 12 is a diagram showing an arrangement of record elements of the record head; and

FIG. 13 is a diagram of the record head as viewed from an ink ejection surface side.

### DESCRIPTION OF THE EMBODIMENTS

### First Embodiment

A preferred embodiment of the present disclosure will be described below with reference to the accompanying drawings. In the present embodiment, the term “recording” (sometimes referred to as “printing”) refers not only to formation of meaningful information such as a character and a figure, but also to formation of meaningful or meaningless information. The term also broadly refers to formation of an image, design, pattern, and the like on a record medium, or processing of a medium, regardless of whether the information is manifested so as to be visually perceived by humans.

In addition, the term “record medium” refers not only to paper used in general recording apparatuses, but also to a cloth, plastic film, metal plate, glass, ceramics, wood, leather, and other materials that can accept ink. Further, the term “ink” (sometimes referred to as “liquid”) should be interpreted broadly in the same way as the definition of “recording (printing)” described above. Thus, the term refers to a liquid that can be applied to a record medium to form an image, design, pattern, and the like or process the record medium, or to process ink (for example, to solidify or insolubilize a colorant in ink applied to the record medium). Furthermore, unless otherwise specified, the term “nozzle” refers to an ejection port or a liquid path that communicates with the ejection port, and the term “record element” refers to an element that is provided corresponding to the ejection port and generates energy used for ink ejection. For example, a record element may be provided in a position opposite to an ejection port. In the present specification, a combination of a “nozzle” and a “record element” is referred to as “ejection element”.

An element substrate (head substrate) for a record head used below does not simply refer to a base body made of a silicon semiconductor, but refers to a configuration provided with elements, wiring, and the like. Further, “on a substrate” refers not only to the top of the element substrate, but also to the front surface of the element substrate and the inner side of the element substrate near the front surface.

<Recording Apparatus Equipped with a Full-Line Record Head>

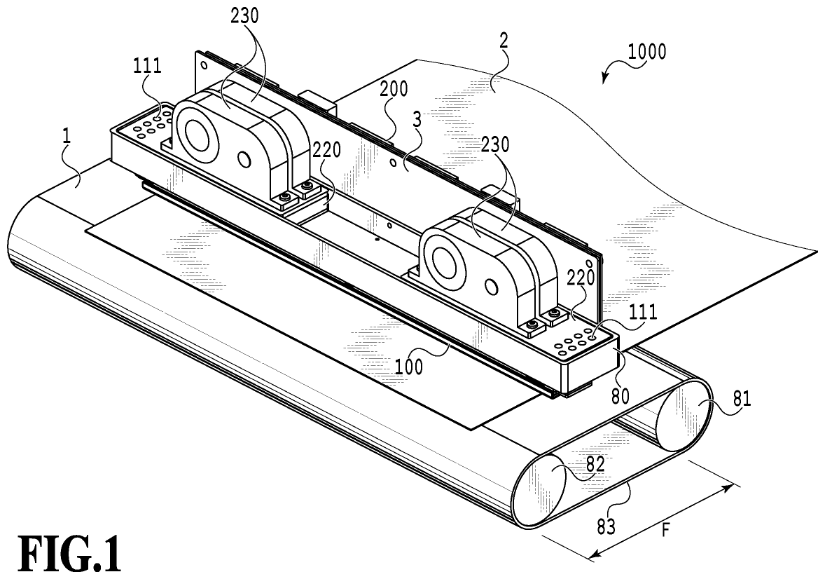

FIG. 1 is a diagram showing the schematic configuration of a recording apparatus 1000 using a full-line record head that ejects ink to perform recording in the present embodiment. As shown in FIG. 1, the recording apparatus 1000 is a line-type recording apparatus that includes a conveying unit 1 that conveys a record medium 2 and a full-line record head 3 arranged approximately orthogonal to a conveyance direction in which the record medium 2 is conveyed, and performs continuous recording while conveying a plurality of record media 2 continuously or intermittently. The full-line record head 3 includes ink ejection elements (not shown) arranged in a direction intersecting the record medium conveyance direction.

The full-line record head 3 includes an ejection unit 100 in which ejection elements are arrayed, a negative pressure control unit 230 that controls pressure (negative pressure) of ink supplied to the ejection unit 100, and a liquid supply unit 220 that connects the negative pressure control unit 230 and the ejection unit 100. The negative pressure control unit 230 and the liquid supply unit 220 are stored inside a housing 80. The ejection unit 100 is provided at the bottom of the housing 80 so as to face the record medium 2. The liquid supply unit 220 is provided with a liquid connection unit 111 that serves as an ink supply and discharge port.

The record medium 2 is not limited to a continuous roll sheet, but may be a cut sheet. The full-line record head (hereinafter, record head) 3 is capable of full-color recording using cyan (C), magenta (M), yellow (Y), and black (K) inks. A main tank (not shown) is connected to the liquid supply unit 220 via the liquid connection unit 111. Further, an electric control unit (200) that transmits power and ejection control signals to the record head 3 is electrically connected to the record head 3. The conveying unit 1 includes two conveyance rollers 81 and 82 spaced apart by a distance F, and a conveyance belt 83 that runs around the conveyance rollers 81 and 82. A motor (not shown) rotates the two conveyance rollers 81 and 82, so that the conveyance belt 83 is rotated, and the record medium 2 placed on the conveyance belt 83 is conveyed.

The record head according to the present embodiment employs an ink jet system that uses thermal energy to eject ink. Thus, each ejection element of the record head 3 is provided with an electrothermal conversion element (heater) as a record element. The electrothermal conversion elements are provided corresponding to respective ejection ports, and ink is heated and ejected from a corresponding ejection port by applying a pulse voltage to a corresponding electrothermal conversion element in response to a record signal. It should be noted that the recording apparatus 1000 is not limited to a recording apparatus using a full-line record head having a recording width corresponding to the width of the above-mentioned record medium. For example, the recording apparatus 1000 can also be applied to a so-called serial type recording apparatus in which a record head having ejection elements arrayed in the record medium conveyance direction is mounted on a carriage and ink is ejected onto a record medium while the carriage is reciprocally scanned to perform recording.

### <Description of a Control Configuration>

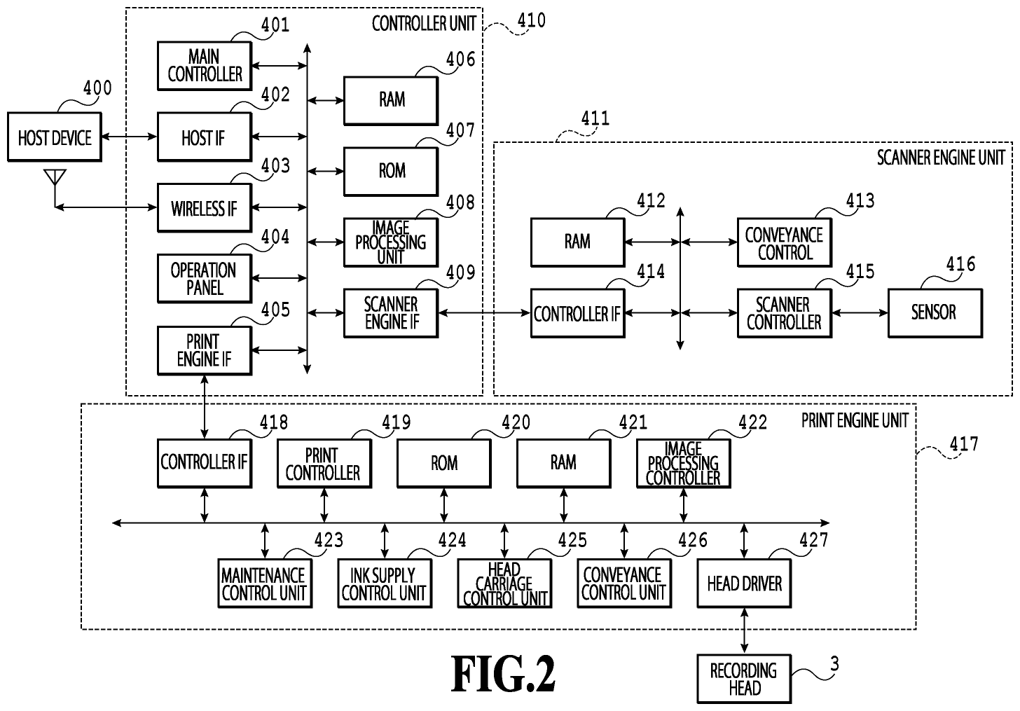

FIG. 2 is a block diagram showing the configuration of a control circuit of the recording apparatus 1000. As shown in FIG. 2, the recording apparatus 1000 mainly includes a print engine unit 417 that controls a recording unit, a scanner engine unit 411 that controls a scanner unit, and a controller unit 410 that controls the entire recording apparatus 1000. A print controller 419 that incorporates an MPU or non-volatile memory (such as an EEPROM) controls various mechanisms of the print engine unit 417 according to an instruction from a main controller 401 of the controller unit 410. Various mechanisms of the scanner engine unit 411 are controlled by the main controller 401 of the controller unit 410. Details of the control configuration will be described below.

In the controller unit 410, the main controller 401 constituted by a CPU controls the entire recording apparatus 1000 in accordance with a program and various parameters stored in a ROM 407 while using a RAM 406 as a work area. For example, in a case where a print job is input from a host device 400 via a host I/F 402 or a wireless I/F 403, an image processing unit 408 performs predetermined image processing on received image data in accordance with an instruction from the main controller 401. The main controller 401 then transmits the image data that has been subjected to the image processing to a print engine unit 417 via a print engine I/F 405. The recording apparatus 1000 may acquire image data from the host device 400 via wireless communication or wired communication, or may acquire image data from an external storage device (such as a USB memory) connected to the recording apparatus 1000. A communication method used for wireless communication or wired communication is not limited. For example, Wi-Fi (Wireless Fidelity) (registered trademark) or Bluetooth (registered trademark) can be used as a communication method used for wireless communication. Further, USB (Universal Serial Bus) or the like can be used as a communication method used for wired communication. For example, in a case where a read command is input from the host device 400, the main controller 401 transmits this command to the scanner engine unit 411 via a scanner engine I/F 409.

The operation panel 404 is a unit through which a user performs input and output to and from the recording apparatus 1000. The user can use the operation panel 404 to instruct operations such as copying or scanning, set a recording mode, and recognize information on the recording apparatus 1000.

In the print engine unit 417, a print controller 419 constituted by a CPU controls various mechanisms of the print engine unit 417 in accordance with a program and various parameters stored in a ROM 420 while using a RAM 421 as a work area.

In a case where various commands or image data is received via the controller I/F 418, the print controller 419 temporarily saves the commands or image data in the RAM 421. The print controller 419 causes the image processing controller 422 to convert the saved image data into recording data so that the record head 3 can use the data for a recording operation. That is, in the present specification, image data refers to data that the recording apparatus 1000 receives from the host device 400 via wireless communication or wired communication. Further, recording data refers to data obtained by converting the received image data so that the data can be recorded by the record head 3. In a case where the recording data is generated, the print controller 419 causes the record head 3 to execute a recording operation based on the recording data via the head driver 427. At this time, the print controller 419 drives the conveyance rollers 81 and 82 (see FIG. 1) via a conveyance control unit 426 to convey the record medium 2. In accordance with an instruction from the print controller 419, the recording operation is executed by the record head 3 in conjunction with an operation of conveying the record medium 2, and record processing is performed.

The head carriage control unit 425 changes the orientation or position of the record head 3 depending on an operation state, such as a maintenance state or a recording state, of the recording apparatus 1000. The ink supply control unit 424 controls the liquid supply unit 220 so that the pressure of ink supplied to the record head 3 falls within an appropriate range. The maintenance control unit 423 controls the operation of a cap unit that covers an ejection port surface of the record head 3 or a wiping unit that wipes the ejection port surface of the record head 3 with a wiper in a maintenance unit (not shown) in performing an operation of maintaining the record head 3.

In the scanner engine unit 411, the main controller 401 controls hardware resources in the scanner controller 415 while using the RAM 406 as a work area in accordance with a program or various parameters stored in the ROM 407. As a result, various mechanisms of the scanner engine unit 411 are controlled. For example, the main controller 401 controls the hardware resources in the scanner controller 415 via the controller I/F 414, conveys a document placed on an ADF (not shown) by a user via a conveyance control unit 413, and reads the document with a sensor 416. The scanner controller 415 then saves the read image data in the RAM 412. The print controller 419 can convert image data acquired as described above into recording data, thereby causing the record head 3 to execute a recording operation based on the image data read by the scanner controller 415.

### <Description of the Configuration of a Temperature Detection Element>

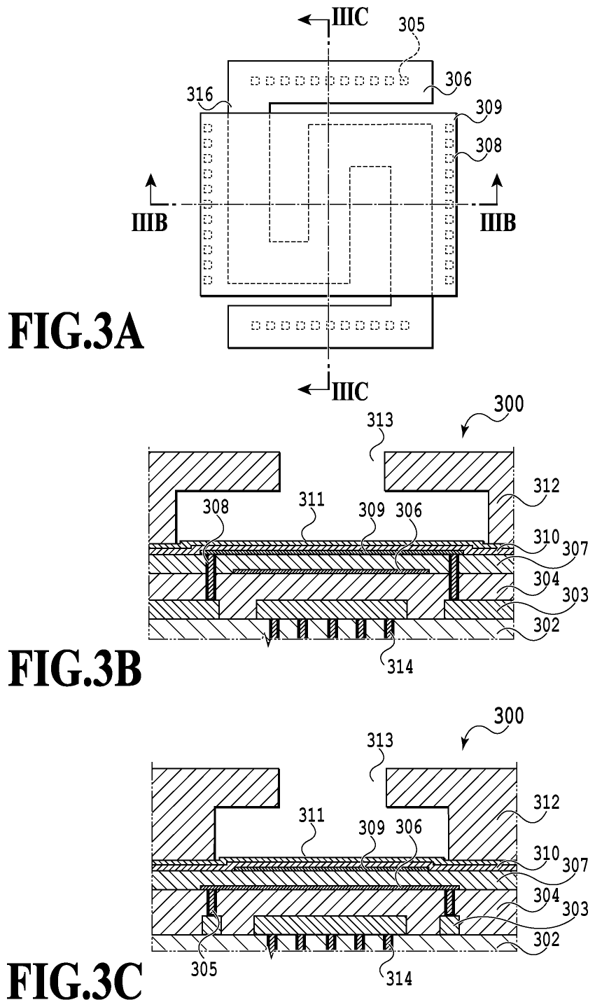

FIGS. 3A to 3C are diagrams for describing a configuration corresponding to one ejection element arrayed in the ejection unit 100. The ejection unit 100 has a multilayer wiring structure formed on a silicon substrate. FIG. 3A is a top view of an ejection element in which a temperature detection element 306 is arranged in a sheet shape below a record element 309 via an interlayer insulation film 307. FIG. 3B is a cross-sectional view taken along dashed line IIIB-IIIB in the top view shown in FIG. 3A. FIG. 3C is a cross-sectional view taken along dashed line IIIC-IIIC shown in FIG. 3A.

An ejection element 300 includes an ejection port 313 formed of a nozzle forming material 312, and a pressure chamber 314 capable of storing liquid to be ejected from the ejection port. The ejection element 300 also includes the record element 309, which is an electrothermal conversion element. In a case where a voltage is applied to the record element 309 in accordance with ejection data, film boiling occurs in liquid stored in the pressure chamber 314, and the liquid is ejected from the ejection port 313 by the growth energy of generated bubbles. The temperature detection element 306 capable of detecting the temperature of the record element 309 is arranged in a position opposite to the pressure chamber 314 with respect to the record element 309. A step of manufacturing a layered structure in the ejection element 300 will be described below.

As shown in the cross-sectional view taken along line IIIB-IIIB shown in FIG. 3B or the cross-sectional view taken along line IIIC-IIIC shown in FIG. 3C, wiring 303 made of aluminum or the like is formed on an insulation film 302 laminated on a silicon substrate, and an interlayer insulation film 304 is further formed on the wiring 303. The wiring 303 is electrically connected to the temperature detection element 306, which is a thin-film resistor made of a laminated film of titanium and titanium nitride or the like, via a conductive plug 305 made of tungsten or the like embedded in the interlayer insulation film 304.

Next, an interlayer insulation film 307 is formed at an upper side of the temperature detection element 306. The wiring 303 is then electrically connected to the record element 309, which is an electrothermal conversion element made of a tantalum silicon nitride film or the like, via a conductive plug 308 made of tungsten or the like penetrating the interlayer insulation film 304 and the interlayer insulation film 307. In connecting a lower conductive plug and an upper conductive plug, the plugs are commonly connected with a spacer made of an intermediate wiring layer interposed therebetween. In the case of being applied to the present embodiment, since the temperature detection element 306, which is an intermediate wiring layer, has a thin film thickness of about several tens of nanometers, during a via hole step, there is a need for accuracy in overetch control of a temperature detection element film which is a spacer. This is also disadvantageous to miniaturization of the pattern of a temperature detection element layer. In consideration of such circumstances, the present embodiment employs the conductive plug 308 penetrating the interlayer insulation film 304 and the interlayer insulation film 307. In order to ensure reliability of electrical connection depending on the depth of a plug, in the present embodiment, the conductive plug 305 having one interlayer insulation film has a diameter of 0.4 μm, and the conductive plug 308 penetrating two interlayer insulation films has a larger diameter of 0.6 μm.

Next, a protective film 310 such as a silicon nitride film is formed, and an anti-cavitation film such as tantalum is formed on the protective film 310 to form a head substrate (element substrate). Further, the ejection port 313 is formed of the nozzle forming material 312 including a photosensitive resin and the like. As describe above, there is formed a multi-layer wiring structure provided with an intermediate layer of the independent temperature detection element 306 between a layer of the wiring 303 and a layer of the record element 309.

The above configuration allows an element substrate used in the present embodiment to obtain temperature information from the temperature detection elements 306 provided corresponding to the respective record elements 309. From the temperature information detected by the temperature detection elements 306 and a temperature change, a determination result signal RSLT indicating an ink ejection state from a corresponding record element can be obtained by a logic circuit (inspection unit) provided inside the element substrate. The determination result signal RSLT is a 1-bit signal, with “1” indicating normal ejection and “0” indicating defective ejection.

### <Description of a Temperature Detection Configuration>

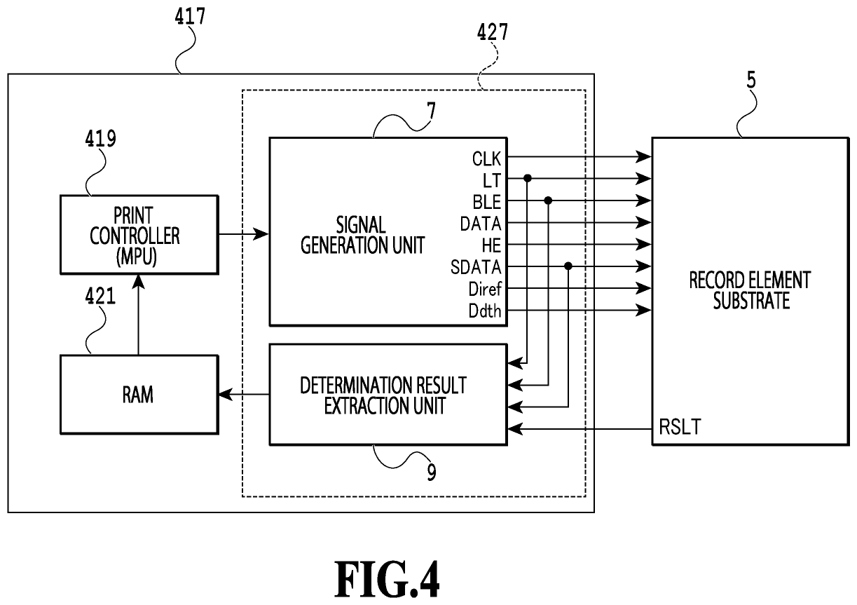

FIG. 4 is a block diagram showing the control configuration of temperature detection using the element substrate shown in FIGS. 3. As shown in FIG. 4, the print engine unit 417 includes a print controller 419 with a built-in MPU, a head driver 427 connected to the record head 3, and a RAM 421 to detect the temperature of the record element 309 mounted on the record element substrate 5. The head driver 427 also includes a signal generation unit 7 that generates various signals to be transmitted to the record element substrate 5 of the record head 3, and a determination result extraction unit 9 that receives input of the determination result signal RSLT output from the record element substrate 5 based on temperature information detected by the temperature detection element 306.

In order to record an image or inspect an ejection state, the print controller 419 issues an instruction to the signal generation unit 7. As a result, the signal generation unit 7 outputs a clock signal CLK, a latch signal LT, a block signal BLE, a recording data signal DATA, and a heat enable signal HE to the record element substrate 5. Further, in inspecting an ejection state in particular, the signal generation unit 7 outputs a sensor selection signal SDATA, a constant current signal Diref, and an ejection inspection threshold signal Ddth.

The sensor selection signal SDATA includes selection information for selecting a temperature detection element that detects temperature information from among a plurality of the temperature detection elements 306 arrayed on the record element substrate 5. Further, the sensor selection signal SDATA includes information for designating the amount of power applied to the selected temperature detection element 306, and information concerning an instruction to output the determination result signal RSLT. For example, in a case where the record element substrate 5 is configured to include five record element arrays each including a plurality of record elements 311, the selection information included in the sensor selection signal SDATA includes array selection information for designating an array and record element selection information for designating the record element 311 in the array. On the other hand, the record element substrate 5 outputs a 1-bit determination result signal RSLT based on temperature information detected by the temperature detection element 306 corresponding to one record element 311 in the array designated by the sensor selection signal SDATA. Accordingly, in a case where the record element substrate 5 is configured to include ten record element arrays, the number of bits of the determination result signal RSLT is two, and the 2-bit signal is output serially to the determination result extraction unit 9 via one signal line.

As can be seen from FIG. 4, the latch signal LT, the block signal BLE, and the sensor selection signal SDATA are fed back to the determination result extraction unit 9. On the other hand, the determination result extraction unit 9 receives the determination result signal RSLT output from the record element substrate 5 based on the temperature information detected by the temperature detection element 306, and extracts a determination result in each latch period in synchronization with the falling edge of the latch signal LT. In a case where the determination result is defective ejection, the block signal BLE and the sensor selection signal SDATA corresponding to the determination result are stored in the RAM 421 as information on a defective ejection nozzle. In performing a recording operation thereafter, the print controller 419 refers to the information on the defective ejection nozzle stored in the RAM 421. Based on the block signal BLE and the sensor selection signal SDATA used to drive the defective ejection nozzle, a signal for driving the defective ejection nozzle is erased from the recording data signal DATA in the corresponding block.

### <Description of a Method for Determining an Ejection State>

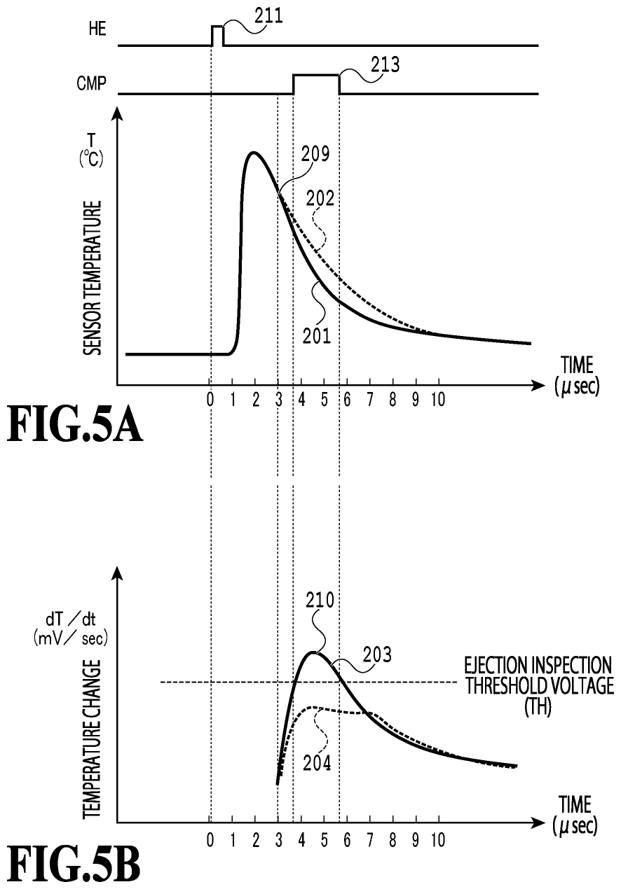

FIGS. 5A and 5B are diagrams showing temperature waveforms output from a temperature detection element and temperature change signals corresponding to the waveforms in a case where a drive pulse is applied to a record element. Although FIG. 5A indicates a temperature waveform (sensor temperature: T) with a temperature (° C.), in reality, a constant current is supplied to the temperature detection element 306, and an inter-terminal voltage (V) of the temperature detection element is detected. Since this detection voltage is temperature dependent, the detection voltage is converted into a temperature and expressed as a temperature in FIGS. 5A and 5B. Further, FIG. 5B is a diagram indicating a time change (mV/sec) in detection voltage by a temperature change signal (dT/dt). Here, the temperature waveform (sensor temperature: T) is shown as a waveform output after passing through a filter circuit (single differentiation) and an inverting amplifier (positive/negative inversion).

As shown in FIG. 5A, in a case where after the drive pulse 211 is applied to the record element 309, ink is ejected normally (in the case of normal ejection), the output waveform of the temperature detection element 306 is like a waveform 201. In the process of decreasing a temperature detected by the temperature detection element 306 indicated by the waveform 201, the tail of an ink droplet (satellite droplet) ejected onto the interface of the record element 309 during normal ejection falls and the interface is cooled. As a result, a feature point 209 appears. After the feature point 209, the temperature decrease rate in the waveform 201 then increases abruptly. Thus, the temperature change signal (dT/dt) takes the waveform 203 in FIG. 5B.

On the other hand, in the case of defective ejection, the output waveform of the temperature detection element 306 changes gradually as shown by the waveform 202 in FIG. 5A, and the feature point 209 does not appear as in the waveform 201 during normal ejection. Thus, the temperature change signal (dT/dt) takes the waveform 204 in FIG. 5B.

In the waveform 203 during normal ejection, there appears a peak 210 due to a maximum temperature decrease rate after the feature point 209 in the waveform 201. On the other hand, in the waveform 204 in the case of defective ejection, no noticeable peak appears. Thus, comparison between an acquired waveform and an ejection inspection threshold voltage (TH) preset in a comparator mounted on the record element substrate 5 makes it possible to determine whether the ejection is normal or defective. Specifically, in a case where the acquired waveform exceeds the ejection inspection threshold voltage (TH) (dT/dt≥TH), the comparator outputs a determination signal (CMP) 213 with a pulse. On the other hand, in a case where the acquired waveform does not exceed the ejection inspection threshold voltage (TH), the comparator does not output the determination signal (CMP) 213.

Therefore, the determination result extraction unit 9 can grasp the ejection state of each nozzle based on the fed back sensor selection signal SDATA and the presence or absence of the corresponding determination signal (CMP) 213. This determination signal (CMP) becomes the above-mentioned determination result signal RSLT.

Incidentally, the ejection determination threshold voltage (TH) may be set by reading a value that is saved in advance in the non-volatile memory of a head and is measured during the manufacture of the head. Alternatively, the optimum ejection determination threshold voltage (TH) predicted from the peak value of the temperature change signal (dT/dt) may be set for each nozzle on the printer body, and is set in an optimum way depending on the system.

### <Description of Block Driving>

The record head 3 used in the recording apparatus 1000 has the increased number of record elements and the drive cycle of the record head 3 is shortened to increase a recording speed. In such a record head, in a case where all record elements 309 are driven simultaneously, power consumption temporarily increases, so that it is necessary to increase power supply capacity to approach the increase. However, increasing the power supply capacity leads to an increase in the cost of the recording apparatus. Thus, as a countermeasure, the number of record elements that are driven simultaneously is reduced by employing time division driving to drive the record elements. This suppresses an increase in instantaneous power consumption. In the time division driving, a plurality of record elements are divided into a plurality of blocks, at certain timing, the maximum number of record elements that are included in each block and driven simultaneously is set to one, and a record element of each divided block is driven in certain order. In this way, all record elements are driven in a case where the driving operations in the order are completed once.

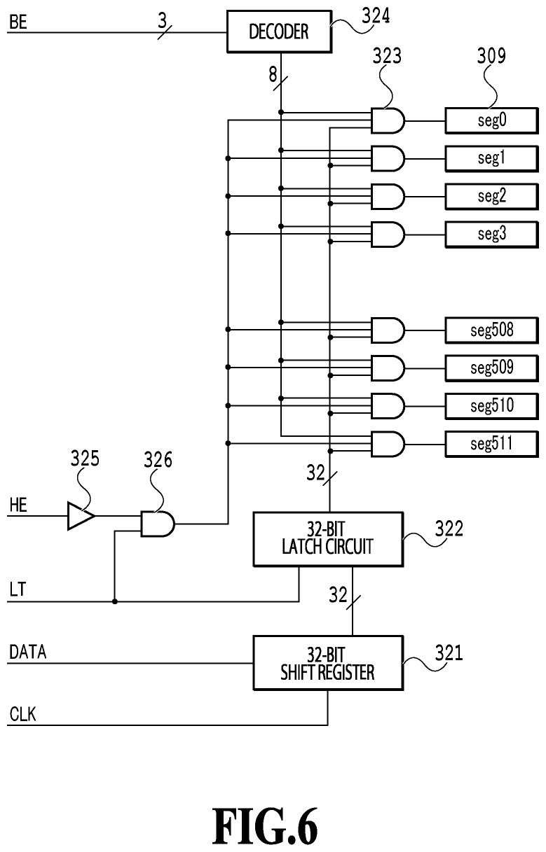

FIG. 6 is a block diagram showing the control configuration of time division driving incorporated into an element substrate. In the drive circuit shown in FIG. 6, the record head 3 includes 512 record elements (Seg0 to Seg511), and these 512 record elements are divided into 8 blocks each including 64 elements to perform time division driving. According to this configuration, each block includes 64 record elements, and these 64 record elements are driven simultaneously. For example, in a case where block drive order is set to 0, 1, 2, . . . , 5, 6, 7, a 3-bit block enable signal BE is used to designate and drive eight blocks from block 0 to block 7 in order. That is, record elements assigned to the blocks are driven in order. This block drive order can be set to be any order and is set appropriately according to the system.

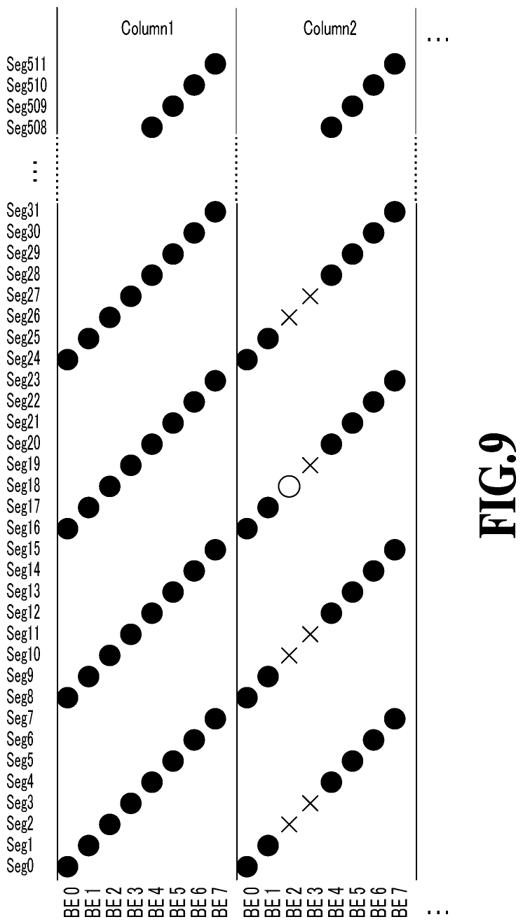

The recording data signal DATA is serially transferred to the element substrate 5 of the record head 3 in synchronization with the clock signal CLK. The recording data signal DATA is received by a 32-bit shift register 321 and then latched by a latch circuit 322 at the rising edge of a latch signal LT. A block to be driven is designated by a three-line block enable signal BE, and the designation signal is expanded by a decoder 324 to select the record elements 309 of the designated block to be driven. The record elements 309 correspond to the record elements (Seg0 to Seg511) shown in FIG. 9, which will be described later.

As can be seen from the configuration in FIG. 6, only a record element designated by both the block enable signal BE and the recording data signal DATA is driven by the heat enable signal HE, and an ink droplet is ejected from a corresponding nozzle. Specifically, the recording data signal DATA and the decoded block enable signal BE, and at the time of the latch signal LT being input, the heat enable signal HE are input to AND circuits 323 provided corresponding to respective record elements. The AND of the signals is calculated in an AND circuit, and a calculation result is output to the record element 309. That is, a voltage pulse is applied to an electrothermal conversion element which is a record element. More specifically, the value of the heat enable signal HE is inverted by an inverter circuit 325, and the AND of the inverted heat enable signal HE and the latch signal LT is calculated in an AND circuit 326. The calculation result is then input to the AND circuits 323. It should be noted that in FIG. 6, a drive transistor for each record element 309 is omitted.

A latch signal input cycle required for high-speed recording in the present embodiment will be described. In order to achieve high-speed recording, there is a need for the recording apparatus to increase the latch signal input cycle shown in FIG. 6 as much as possible. Signals required to drive a record head, such as the above-mentioned recording data signal DATA or the decoded block enable signal BE, must be input within the latch signal input cycle. In a case where predetermined various signals cannot be transferred within the latch signal input cycle, a record element cannot be driven based on correct recording data, and a defect occurs in an image. Thus, time required for complete transfer of signals required for recording is a minimum latch signal input cycle, which is an upper limit to the recording speed. In the present embodiment, a frequency at which various signals are transferred is 160 MHz, and the capacity of signals required for recording, such as the data signal DATA, is 480 bits. The minimum latch input cycle at this time is 3.0 μsec (480 bits×6.25 ns/bit).

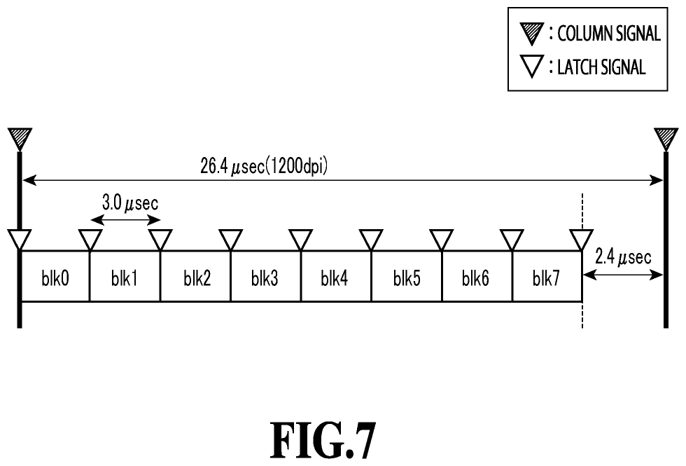

FIG. 7 is a schematic diagram of latch signal input timing. A period (3.0 μsec) from latch signal input timing to the next latch input timing is expressed as “blkN” in association with a number N (0 to 7) for the selected block enable signal BE. A column signal is output from the conveyance control unit in conjunction with an operation of conveying a record medium so that dots can be recorded on the record medium at a resolution of 1200 dpi (21.2 μm). Eight latch signals are output based on this column signal. Since a latch signal output cycle is 3.0 μsec, all block enable signals BE are selected in order over 24.0 μsec. Since there is an error in record medium conveyance accuracy, the next column signal is output with a margin of about 10% (2.4 μsec) of 24.0 μsec. In other words, the cycle of the eight latch signals and the column signal including 2.4 μsec for a margin is 26.4 μsec. The record medium conveyance speed at this time is 0.8 m/sec, which is approximately a maximum recording speed that can be implemented in the present embodiment.

In the present embodiment, in order to detect the ejection state of any ejection element, it is necessary to drive a record element corresponding to the ejection element and check the presence or absence of a feature point that occurs certain time after a liquid droplet is ejected, and the required time is about 5.0 μsec. Thus, the ejection state of any ejection element cannot be determined within a block cycle of 3.0 μsec assigned to the ejection element. In order to detect the ejection state of any ejection element, it is necessary to use a block assigned to the ejection element and time until the next block. It should be noted that there is no need for a maximum recording speed in the system, and for example, in a case where recording is performed at a latch signal cycle of 5.0 μsec, the ejection state can be detected within one driving block section.

### <Description of an Ejection Inspection Pattern>

A description will be given of an embodiment in which in the recording apparatus configured as above, an ejection inspection pattern is inserted into recording data for detecting an ejection state while any image data is being recorded to generate drive-recording data to be finally ejected by a record head.

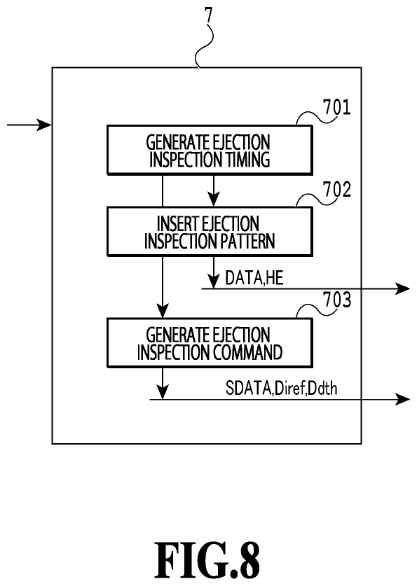

FIG. 8 is a block diagram of the signal generation unit 7 (see FIG. 4) in the present embodiment. The signal generation unit 7 according to the present embodiment includes an ejection inspection timing generation unit 701, an ejection inspection pattern insertion unit 702, and an ejection inspection command generation unit 703. The ejection inspection timing generation unit 701 designates the timing of ejection inspection in a block to be subjected to ejection state detection based on a predetermined cycle or the like. The ejection inspection pattern in the present embodiment is a pattern in which ejection data on an ejection element to be inspected in an inspection block is set to driven (ON) and a simultaneous ON nozzle not to be inspected is not driven (OFF). Further, the ejection inspection pattern insertion unit 702 sequentially designates a record element to be subjected to ejection state detection for each ejection inspection timing. For example, the ejection inspection timing generation unit 701 issues an instruction to execute detection of an ejection state in a second column, and in response to this, the ejection inspection pattern insertion unit 702 determines to detect the ejection state of a record element seg18 and modifies the recording data signal DATA to be transmitted to a record head. That is, among the recording data signal DATA based on image data, data to be subjected to an ejection inspection pattern for the ejection inspection of the record element seg18 is replaced with an ejection inspection pattern generated by the ejection inspection pattern insertion unit 702. Recording data resulting from the process will be referred to as drive-recording data. The ejection inspection timing is also transmitted to the ejection inspection command generation unit 703, and the inspection command generation unit 703 outputs a sensor selection signal SDATA, a constant current signal Diref, and an ejection inspection threshold signal Ddth corresponding to the record element to be inspected in accordance with the received ejection inspection timing.

FIG. 9 is a diagram showing an ejection inspection pattern. A change to the recording data signal DATA made by the signal generation unit 7 will be described with reference to FIG. 9. In the figure, Seg refers to a record element as described in FIG. 6, and in FIG. 9, a record head includes 512 elements from Seg0 to Seg511. As described in FIG. 6, the record elements are assigned to eight blocks (BE0 to BE7) in FIG. 9 as well. In the present embodiment, 64 record elements are assigned to one block as shown in FIG. 9. Specifically, every eighth record element, such as Seg0, Seg8, Seg16, Seg24, Seg32, Seg40 . . . , is assigned regularly to BE0. As shown in FIG. 9, record elements are also assigned regularly from BE1 onwards.

Recording data input via the print controller 419 is allocated to a corresponding record element and drive timing based on BE and Seg numbers in the signal generation unit 7. FIG. 9 shows an allocation state in a case where so-called solid recording is performed. The solid recording is a state where all ejection elements record one dot at a time in all columns. For example, in the case of putting a focus on a first column (Column 1), all record elements (Seg0 to Seg511) are driven at timing in any one of the eight blocks (BE0 to BE7), and each black circle (●) indicates timing (i.e., a block) at which a record element is driven.

The figure shows the case of performing detection of the ejection state of a record element Seg18 assigned to BE2 in the second column (Column 2). A position (Seg18, BE2) to be subjected to ejection inspection is indicated by a white circle (○).

Here, since the record element Seg18 is test-driven in the third block (BE2) of the second column, in an ejection inspection pattern, the recording data signals DATA of record elements Seg2, 10, 26, . . . that may be driven at the same time as Seg18 are set to non-driven. In the figure, this position is indicated by a cross (×). That is, in the present embodiment, a record element assigned to the same block as a record element to be subjected to ejection state detection is set not to be driven even in a case where recording data indicates recording (driven).

The reason why recording is not performed by a record element assigned to the same block as that of a record element to be inspected is that in a case where at the same time as a record element to be subjected to ejection state detection, another record element is driven, electrical noise may be included in data acquired by the temperature detection element 306. In a case where noise is included in the data, it may not be possible to correctly perform ejection state determination as described in FIGS. 5A and 5B.

As shown in FIG. 9, in the present embodiment, a subsequent block (for example, BE3 in a case where a record element to be detected is assigned to BE2) is also set to non-driven (×). This is because required time from driving of a record element until a feature point is checked is longer than a block cycle. For example, in a case where the required time is shorter than the block cycle, the subsequent block may not be included in an ejection inspection block, and the ejection inspection block may only be BE2. In contrast, in a case where the required time is twice or more the block cycle, it is preferable to further increase the number of subsequent blocks included in the ejection inspection block and set the subsequent blocks to non-driven (×).

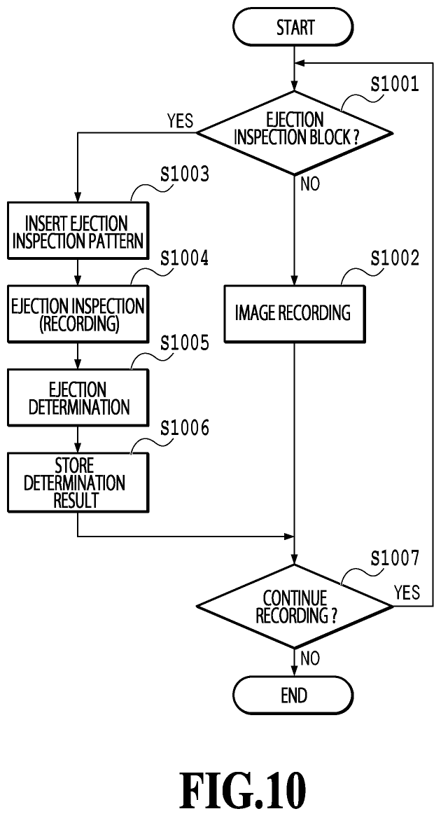

FIG. 10 is a flow diagram of ejection inspection in the present embodiment. The present process is started by receiving a record instruction from a user and executing recording processing. That is, the ejection inspection is executed while recording is being performed. The present process is executed by the main controller 401 expanding a program stored in the ROM 407 into the RAM 406. It should be noted that “S” in the following description of each process means a step in a sequence diagram.

In S1001, the main controller 401 determines whether a target block (BE) is an ejection inspection block (a block to be subjected to ejection state detection). The ejection inspection block refers to a driving block including a nozzle to be inspected and corresponds to a two-block section including BE2 and BE3 in Column 2 in FIG. 9. The determination processing is performed according to ejection inspection timing generated by the ejection inspection timing generation unit 701. For example, in the case of performing an inspection as shown in FIG. 9, the determination result is No in this step up to BE2 in the second column. In the blocks BE2 and BE3 in the second column, the determination result is Yes in this step based on the ejection inspection timing generation unit 701. In a case where it is determined that the target block is an ejection inspection block, the main controller 401 proceeds to S1003. In a case where it is determined that the target block is not an ejection inspection block, the main controller 401 proceeds to S1002.

In S1002, the main controller 401 performs drive control based on recording data for an ejection target block (normal recording block) that is not an ejection inspection block, without executing ejection inspection pattern insertion or the like for ejection state inspection, and records an image.

In S1003, the main controller 401 inserts an ejection inspection pattern. That is, the recording data is replaced with a predetermined ejection inspection pattern. The ejection inspection pattern is, for example, a pattern, as described in FIG. 9, in which a simultaneous on nozzle not to be inspected in an inspection block is not driven. In the case of FIG. 9, data areas from Seg0 to Seg511 of BE2 and BE3 in Column 2 are in the ejection inspection pattern.

In S1004, the main controller 401 performs drive control over the ejection inspection block based on the ejection inspection pattern. As a result, ink is ejected only with a record element to be inspected. In S1005, the main controller 401 performs ejection determination using the temperature detection element 306. Specifically, whether a temperature change signal (dT/dt) (see FIGS. 5A and 5B) acquired from the temperature detection element 306 exceeds the ejection inspection threshold signal Ddth output from the ejection inspection command generation unit 703 is detected. In a case where the temperature change signal exceeds the ejection inspection threshold signal Ddth, the ejection state of a record element to be inspected is determined to be “normal,” and in a case where the temperature change signal is equal to or lower than the ejection inspection threshold signal Ddth, the ejection state of the record element is determined to be “defective.”

In S1006, the main controller stores the result of the above determination as the determination result signal RSLT in the RAM 421 of the print engine unit 417. In S1007, the main controller 401 determines whether recording based on image data is completed. In a case where it is determined that the recording is not completed, the main controller 401 returns to S1001. That is, the recording is continued. In a case where it is determined that the recording is completed, the main controller 401 ends the process in the present flowchart. The above is the flowchart of ejection inspection according to the present embodiment. In a case where a block to be ejected is an ejection inspection block, it is possible to execute ejection inspection of a record element even during recording of image data by inserting an ejection inspection pattern.

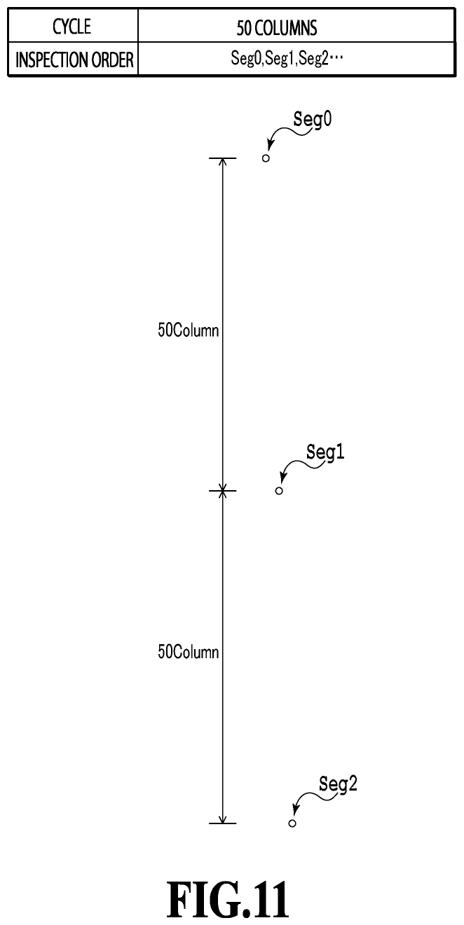

FIG. 11 is a diagram describing an example of an ejection inspection pattern. The ejection inspection timing generation unit 701 sets the number of columns in an image as a cycle in which an inspection is executed, stores the number in memory, and executes an ejection inspection for each cycle. The ejection inspection timing generation unit 701 also has a table in which all nozzles of a record head are to be inspected in any order as inspection order.

FIG. 11 shows an arrangement of dots recorded by an ejection inspection on a paper surface in a case where an inspection cycle is 50 columns and order in which record elements are inspected is ascending order from the first one (Seg0, Seg1, Seg2, . . . ). In a case where inspection dots with a diameter of about 30 μm are arranged at a cycle of about 1 mm (1200 dpi, 50 columns), an inspection dot unrelated to image data is difficult to see even on a blank sheet. It is possible to set the inspection cycle shorter. However, since many record elements within the cycle are not driven, margins become noticeable and there is a possibility that the quality of a product deteriorates.

In a case where 4092 nozzles (512 nozzles×8 arrays) in a chip are inspected once by inspecting the ejection of each nozzle at intervals of about 1 mm, about 5 m of image data passes. In the full-line record head in FIG. 1, 17 chips are arranged in parallel, and each of the 17 chips is equipped with equivalent nozzles and circuits and can be driven independently. The nozzle order and timing of ejection inspection for each chip can be set independently. However, since there may be problems such as ejection inspection dots being close to each other between adjacent chips, in the present embodiment, the ejection inspection is performed in the same order and at the same timing for all chips to be inspected. Further, depending on the width of a record medium being recorded, there may be a chip that is not used for recording. In that case, the ejection inspection is individually set not to be performed for the chip that is not used according to the setting of the width of the medium. Nozzles at the ends of nozzle chips on both ends are also not used for recording on the widest record medium that can be used in the recording apparatus. The ejection inspection is always set not to be performed for nozzles not to be used.

The ejection inspection results stored in S1006 in FIG. 10 are updated in the order of inspection as the recording of the image data progresses. Continuing recording with a head with many ejection failures increases the risk of image defect occurrence. Thus, time between pages, which is the delimitation of image data, is used to notify a non-ejection complement module (not shown) of the latest ejection inspection result (non-ejection nozzle information) and process the result as a non-ejection complement target to avoid image defects. Specifically, pixel data is allocated so that an image is recorded with a normal nozzle that is not a non-ejection nozzle. While it is assumed that there are multiple page intervals per second, it takes more than ten seconds (5 m as mentioned above) for ejection inspection results to be updated for all nozzles. Thus, in consideration of a balance with a processing load, it is reasonable to wait at least a cycle in which results of inspection of all nozzles are updated and then acquire non-ejection information and reflect the information in a non-ejection complement.

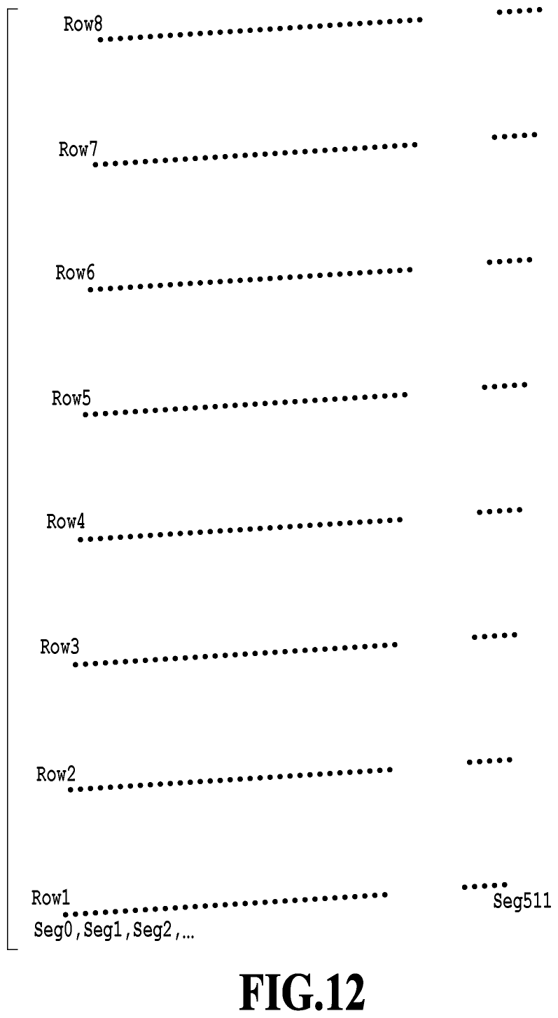

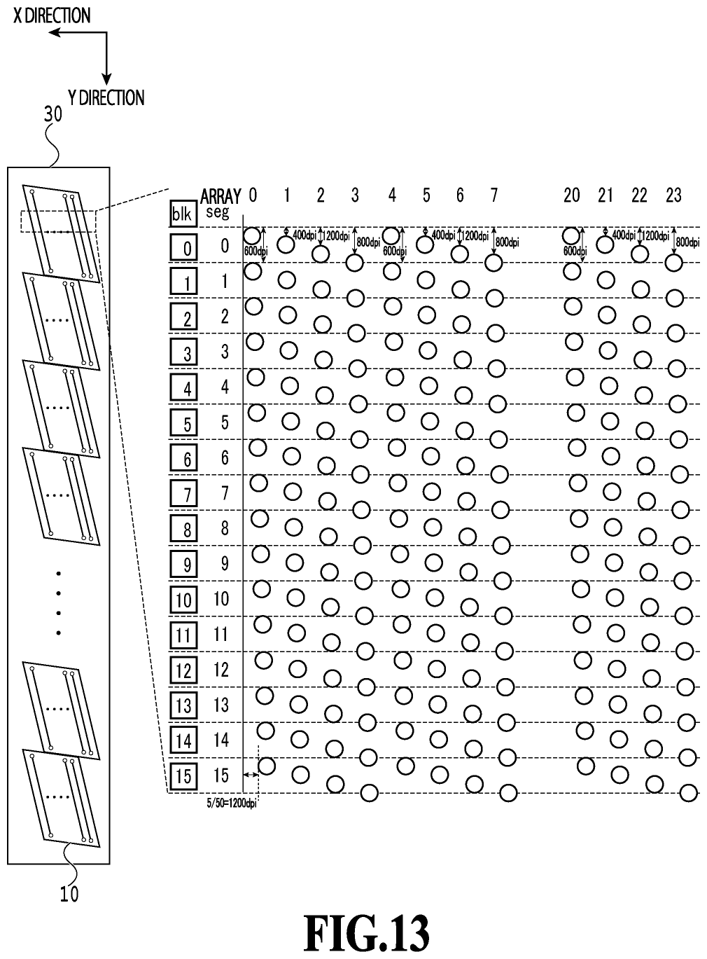

FIG. 12 is a partially enlarged view of an arrangement of nozzles (record elements) of the record head 3 in the present embodiment. The description has been given above on the assumption that one nozzle array of the record head 3 is targeted. However, in an actual line head, a plurality of chips each provided with more nozzle arrays are often arrayed. FIG. 13 is a diagram showing the print head 30 as viewed from an ink ejection surface side. As shown in FIG. 12, the print head 30 is constituted by connecting a plurality of head chips (head substrates) 10, each of which has a parallelogram shape, in the Y direction. In each head chip, 24 nozzle arrays are arranged, and nozzles constituting each nozzle array are arranged diagonally in the X direction at a pitch of a resolution of 600 dpi. Although the nozzles in each nozzle array are arrayed at a pitch of a resolution of 600 dpi, between the arrays, the nozzles are shifted by ¼ pitch in the nozzle array direction and are arrayed. Thus, combining four consecutive nozzle arrays, such as arrays 0 to 3 and arrays 4 to 7, makes it possible to achieve recording with a resolution of 2400 dpi in the Y direction. For this reason, there may be nozzles inspected simultaneously in parallel in a certain block according to the number of chips. Further, providing separate circuits so that the chips are not affected by inspection noise also enables simultaneous inspection of a plurality of lines. Using a record head in which eight arrays of nozzles are arrayed substantially in parallel as in FIG. 12 enables recording at a higher resolution as compared with the case of nozzle intervals in an array. Further, since a plurality of nozzles are arrayed on the same raster, it is possible to perform high concentration recording by overlapping droplets ejected from the plurality of nozzles on a paper surface.

In a case where such a multi-array head is used, it is possible to reduce effects on an image in a case where the above-mentioned ejection pattern is inserted. For example, even in a case where original recording data is thinned out by an ejection inspection pattern and a missing dot (blank dot) occurs on an actual image, in the case of a multi-array head, the recording data can be supplemented (complemented) with nozzles of another array, so that the missing dot becomes less visible. Thus, a record head with eight or more nozzle arrays arrayed as shown in FIG. 12 is preferable.

In the multi-array head, it is advisable to inspect nozzles in sequence as described above, store results, and then link the results to the non-ejection complement module in a case where all nozzles have been inspected. Specifically, in S1001, a block is set to be an ejection inspection block at intervals of approximately 1 mm (50 columns), and non-ejection nozzle information is accumulated in S1003 to S1006. For example, in a case where the length of a page is 1 m, information on a nozzle to be subjected to a non-ejection complement is replaced collectively between page 5 (5 m) and page 6. Since there is a time lag of about one second in the memory transfer, and it is impossible to reflect the non-ejection complement module in data that has already passed, non-ejection complement processing is performed after a few seconds (around the 8th page) according to the updated non-ejection nozzle information.

As described above, according to the present embodiment, it is possible to inspect the ejection state of a head during recording of an actual image. Specifically, an ejection inspection pattern is inserted into a target block at a specific cycle during the recording of the actual image. This makes it possible to inspect the ejection state of a record element without deteriorating the quality of a finished product after recording.

Of course, the ejection state inspection within the actual image described above can be executed by ejecting ink onto the cap unit by repeating ejection only by an ejection inspection block in the state of apparatus standby where no recording operation is performed. Since non-ejection can be complemented from a tip of the actual image by sequentially inspecting the ejection of all nozzles inside the cap during standby or operations of job input, RIP processing, and main body preparation (for example, time required for preheating a fixing and drying unit or for stabilizing the conveyance of roll media), it is more preferable to perform the ejection state inspection in combination with the in-image ejection inspection in FIG. 10.

### Other Embodiments

The effect of the above-mentioned embodiment is not necessarily produced only by the use of a line head. For example, multi-pass recording may be adopted in which a serial type record head in which two nozzle arrays arrayed at 600 dpi are shifted by 1200 dpi in a nozzle array direction is used to scan multiple times the same image area of a record medium. In this case, in a position where a dot has been thinned out by an ejection inspection pattern in a record scan, a dot can be recorded in another record scan. Even in such a configuration, downtime for inspection can be avoided by inserting an ejection inspection pattern in the manner as described in the above embodiment.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-200414, filed Nov. 28, 2023, and No. 2024-165404, filed Sep. 24, 2024, which are hereby incorporated by reference wherein in their entirety.

What is claimed is:

1. A recording apparatus comprising:
a record head having a plurality of record elements for ejecting a recording agent and configured to record an image on a record medium by driving the plurality of record elements;
a drive control unit configured to drive the plurality of record elements while the plurality of record elements are divided into a plurality of blocks to vary driving timing for each block;
a generation unit configured to generate drive-recording data in which an ejection inspection pattern for inspecting ejection states of the record elements is reflected in recording data generated based on image data; and
an inspection unit configured to inspect an ejection state of a record element to be inspected driven based on the ejection inspection pattern,
wherein the generation unit generates the drive-recording data so that the drive control unit does not drive a record element other than the record element to be inspected in a block that includes the record element to be inspected.

2. The recording apparatus according to claim 1, wherein the generation unit generates the drive-recording data so that the drive control unit does not drive all record elements in a block driven following the block that includes the record element to be inspected.

3. The recording apparatus according to claim 1, wherein the generation unit generates the drive-recording data by reflecting an ejection inspection pattern for inspecting an ejection state of a predetermined record element in recording data, and after a specific cycle, generates the drive-recording data by reflecting an ejection inspection pattern for inspecting an ejection state of a record element different from the predetermined record element in the recording data.

4. The recording apparatus according to claim 3, wherein the specific cycle is 50 columns.

5. The recording apparatus according to claim 3, wherein the specific cycle is about 1 mm.

6. The recording apparatus according to claim 1, wherein based on a change in a temperature of a record element driven based on the ejection inspection pattern, the inspection unit inspects an ejection state of the record element.

7. The recording apparatus according to claim 1, wherein the record head has a nozzle array including a plurality of the record elements.

8. The recording apparatus according to claim 7, wherein the record head has a plurality of the nozzle arrays.

9. The recording apparatus according to claim 8, wherein in a case where the inspection unit determines that the ejection state of the record element to be inspected is abnormal, the record element to be inspected is not driven during recording of an image.

10. The recording apparatus according to claim 8, further comprising a complementing unit configured to complement, in a case where the inspection unit determines that the ejection state of the record element to be inspected is abnormal, the record element to be inspected using a record element of another nozzle array.

11. The recording apparatus according to claim 10, wherein after the inspection unit completes inspection of all record elements of the record head, the complementing unit reflects results of the inspection of all of the record elements in a complement.

12. The recording apparatus according to claim 10, wherein the complementing unit reflects inspection results by the inspection unit in a complement every several pages.

13. The recording apparatus according to claim 7, wherein
the record head has a plurality of chips in which a plurality of record elements are arrayed,
the drive control unit drives the plurality of record elements according to the recording data while the ejection inspection pattern is divided into a plurality of blocks for each chip to vary driving timing for each block, and
the ejection inspection pattern is generated so that a record element that performs ejection at same timing of another chip is targeted to be inspected.

14. The recording apparatus according to claim 7, wherein the inspection unit does not target, for inspection, a nozzle outside a width of the record medium on which an image is recorded.

15. The recording apparatus according to claim 1, further comprising a cap, wherein
the record head has an ejection port surface on which an ejection port for ejecting ink is provided corresponding to a record element,
the cap covers the ejection port surface, and
the inspection unit performs, in addition to inspection using the drive-recording data, inspection of the ejection state of the record element to be inspected driven by driving the record element so as to eject ink to the cap.

16. A method of controlling a recording apparatus comprising a record head having a plurality of record elements for ejecting a recording agent and configured to record an image on a record medium by driving the plurality of record elements, the method comprising:
driving the plurality of record elements while the plurality of record elements are divided into a plurality of blocks to vary driving timing for each block;
generating drive-recording data in which an ejection inspection pattern for inspecting ejection states of the record elements is reflected in recording data generated based on image data; and
inspecting an ejection state of a record element to be inspected driven based on the ejection inspection pattern,
wherein in the generating, the drive-recording data is generated so that the driving does not drive a record element other than the record element to be inspected in a block that includes the record element to be inspected.

17. A non-transitory computer readable storage medium storing a program which functions in a recording apparatus comprising a record head having a plurality of record elements for ejecting a recording agent and configured to record an image on a record medium by driving the plurality of record elements and causes the recording apparatus to function as:
a drive control unit configured to drive the plurality of record elements while the plurality of record elements are divided into a plurality of blocks to vary driving timing for each block;
a generation unit configured to generate drive-recording data in which an ejection inspection pattern for inspecting ejection states of the record elements is reflected in recording data generated based on image data; and
an inspection unit configured to inspect an ejection state of a record element to be inspected driven based on the ejection inspection pattern,
wherein the generation unit generates the drive-recording data so that the drive control unit does not drive a record element other than the record element to be inspected in a block that includes the record element to be inspected.
